(19) United States
(12) Patent Application Publication
(10) Pub. No.: US 2026/0155615 A1
(43) Pub. Date: Jun. 4, 2026

(54) ELECTRICAL CONNECTOR MANUFACTURING METHOD

(71) Applicant: ACES ELECTRONICS CO., LTD., Taoyuan City (TW)

(72) Inventors: Chu-Cheng WU, Taoyuan City (TW); Rui-Ping WANG, Taoyuan City (TW); MICKEY FELTON, Taoyuan City (TW)

(21) Appl. No.: 18/968,121

(22) Filed: Dec. 4, 2024

(51) Int. Cl. H01R 43/20

(52) U.S. Cl. CPC H01R 43/205

(57) ABSTRACT

An electrical connector manufacturing method includes the steps of: S1: providing cables including a plurality of front-row cables of longer length and a plurality of rear-row cables of shorter length to keep front-row cables and rear-row cables in a staggered arrangement; S2: forming a wire rack assembly on the outside of cables by plastic injection molding; S3: bending front-row cables on the front side of wire rack assembly to avoid interfering with stripping of rear-row cables, and then stripping rear-row cables to expose wire cores thereof; S4: stripping front-row cables that have been bent to expose the wire cores thereof; and S5: first, soldering rear-row cables to a plurality of rear-row solder pads of circuit board, and then restoring bent front-row cables and soldering front-row cables to a plurality of front-row solder pads of circuit board to keep front-row solder pads and rear-row solder pads in a staggered arrangement.

### BACKGROUND OF THE INVENTION

### 1. Field of the Invention

The present invention is a method for manufacturing an electrical connector, particularly a method for manufacturing an electrical connector in which a plurality of front-row cables and a plurality of rear-row cables are arranged in a front-to-back staggered manner on a circuit board to improve the far-end crosstalk (FEXT) problem when transmitting high-frequency signals. Furthermore, the wire rack assembly formed on the outside of the plurality of cables can provide a fixed distance between the front-row cables and the rear-row cables to reduce the coupling effect between adjacent cables and improve the cable near-end crosstalk (NEXT) and far-end crosstalk problems.

### 2. Description of the Related Art

In order to maintain the optimal electrical characteristics when cables are coupled to electronic devices, discontinuities in system impedance must be avoided in order to maintain a fixed impedance. Installing an electrical connector between the cable and the electronic device will create impedance discontinuity at the junction, further causing insertion loss that reduces signal strength, and return loss where the signal is reflected back to the signal source.

As mentioned above, insertion loss is related to the cable length and the number of connection points. The longer the cable or the more connection points there are, the greater the loss. Return loss refers to the energy reflected back to the signal source due to impedance mismatch or discontinuity during signal transmission within the conductor. These parameters have a significant impact on the transmission speed, integrity and reliability of high-frequency signals.

Furthermore, in high-frequency characteristics, near-end crosstalk (NEXT) and far-end crosstalk (FEXT) are two common problems. Near-end crosstalk refers to the interference signal being coupled to the adjacent cable near the signal source and affecting the integrity of the signal. Far-end crosstalk refers to the interference signal being coupled to the adjacent cable near the signal receiving end, causing signal distortion. The impact of far-end crosstalk (FEXT) is usually greater than near-end crosstalk (NEXT), because it accumulates and increases the interfering signal energy over the cable length. Because of the various problems mentioned above when the cable is coupled to the electrical connector, it is necessary for those engaged in this industry to solve them by optimizing the structure of the electrical connector.

### SUMMARY OF THE INVENTION

Therefore, in view of the above problems and deficiencies, the inventor collected relevant information and, after multiple evaluations and considerations, designed the invention of this electrical connector manufacturing method.

The main object of the present invention is to provide an electrical connector manufacturing method, comprising the steps of: S1: providing a plurality of cables including a plurality of front-row cables of a longer length and a plurality of rear-row cables of a shorter length, and arranging the front-row cables and the rear-row cables in a staggered manner; S2: forming a wire rack assembly on the outside of the cables by plastic injection molding; S3: bending the front-row cables on the front side of the wire rack assembly to avoid interfering with stripping of the rear-row cables, and then stripping the rear-row cables to expose the wire cores thereof; S4: stripping the bent front-row cables to expose the wire cores thereof; and S5: first, soldering the rear-row cables to a plurality of rear-row solder pads of a circuit board, and then restoring the bent front-row cables and soldering the front-row cables to a plurality of front-row solder pads of the circuit board to keep the front-row solder pads and the rear-row solder pads in a staggered arrangement. By placing multiple front-row cables and multiple rear-row cables in a front-to-back staggered arrangement on the circuit board, the far-end crosstalk (FEXT) problem when transmitting high-frequency signals can be improved. Furthermore, the wire rack assembly formed on the outside of the cables can provide a fixed distance between the front-row cables and the rear-row cables to reduce the coupling effect between adjacent cables and improve the cable near-end crosstalk (NEXT) and far-end crosstalk (FEXT) problems.

Preferably, step S31 is further included between the step S3 and the step S4, wherein the wire rack assembly is rotated 90 degrees to rotate the front-row cables to the stripping position of the rear-row cables, and then step S4 is performed.

Preferably, further comprising step S6, the wire rack assembly comprises an upper wire rack and a lower wire rack, a plurality of protruding buckles on opposite outer sides of the upper wire rack and the lower wire rack for positioning a plurality of buckle grooves of a grounding plate, and then deform and expand respective tops of the protruding buckles of the upper wire rack and the lower wire rack by heating and pressing to fix the grounding plate, so that the grounding plate is fixed to the opposite outer sides of the upper wire rack and the lower wire rack.

Preferably, further comprising step S7, which is to insert the wire rack assembly with the grounding plate assembled into the outer housing of the insulating housing for positioning, and make the circuit board engage with the outer housing for fixing, and then push the inner housing of the insulating housing from the back of the wire rack assembly and fix the inner housing inside the outer housing through buckles, fixing grooves and insert molding method.

Preferably, further comprising step S8, which is to install a locking spring sheet on the top side of the outer housing of the insulating housing, and then install a pull strap on the top side of the locking spring sheet.

### BRIEF DESCRIPTION OF THE DRAWINGS

FIG. 1 is a three-dimensional external view of the electrical connector of the present invention.

FIG. 2 is a three-dimensional external view of the electrical connector of the present invention from another viewing angle.

FIG. 3 is a three-dimensional exploded view of the electrical connector of the present invention.

FIG. 4 is a three-dimensional exploded view of the electrical connector of the present invention from another viewing angle.

FIG. 5 is a side cross-sectional view of the electrical connector of the present invention.

FIG. 6 is another side cross-sectional view of the electrical connector of the present invention.

FIG. 7 is a more detailed three-dimensional exploded view of the internal components of the electrical connector of the present invention.

FIG. 8 is a more detailed three-dimensional exploded view of the internal components of the electrical connector of the present invention from another viewing angle.

FIG. 9 is a flow chart of the steps of the electrical connector manufacturing method of the present invention.

### DETAILED DESCRIPTION OF THE PREFERRED EMBODIMENT

In order to achieve the above-mentioned purpose and effect, the technical means and structure adopted by the present invention are described in detail with reference to the preferred embodiment of the present invention accompanying with the annexed drawings, and its features and functions are as follows for a complete understanding.

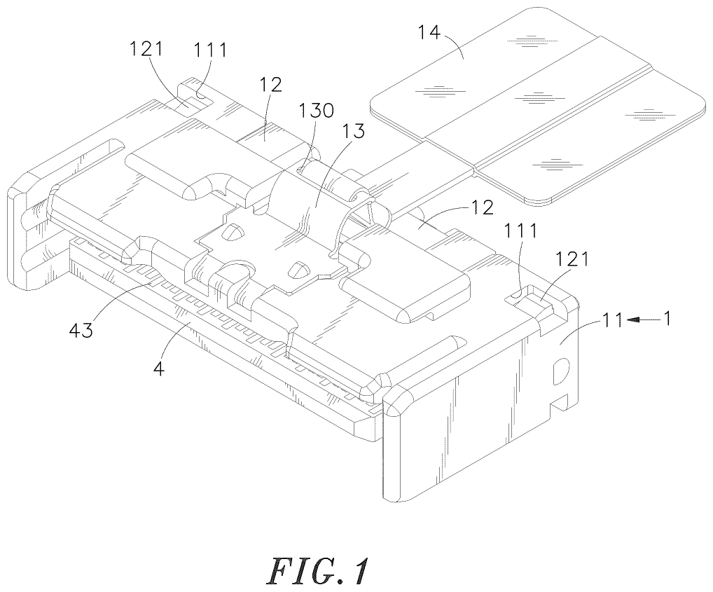

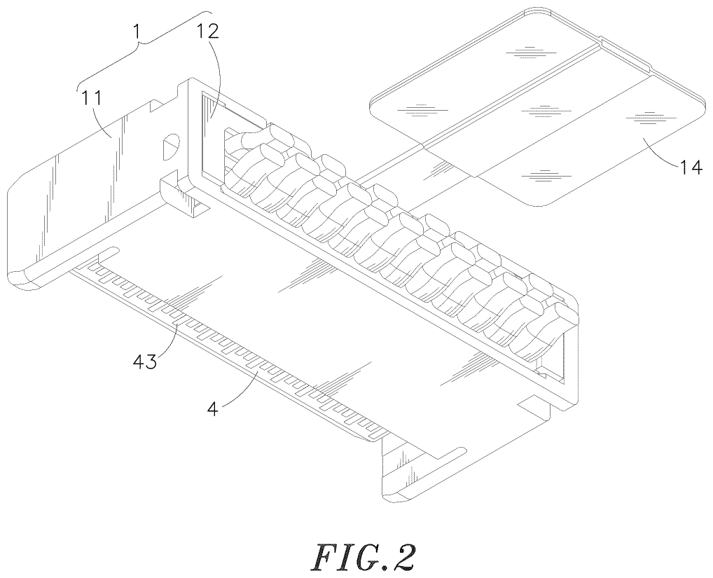

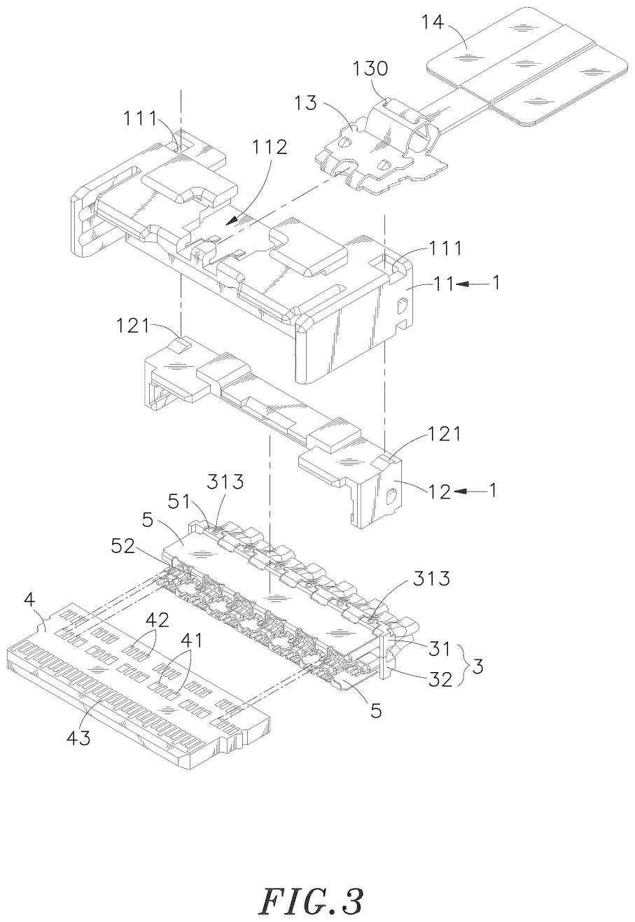

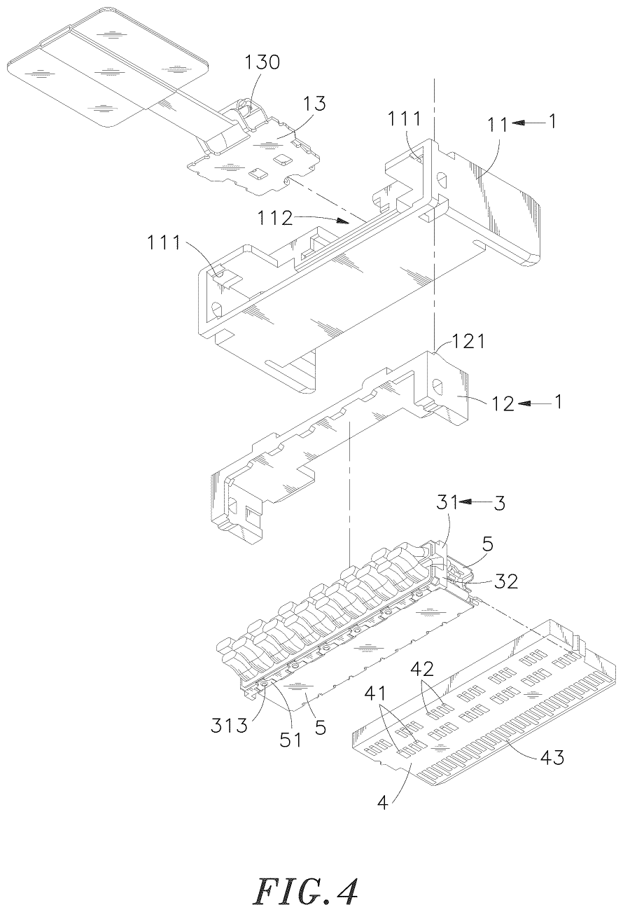

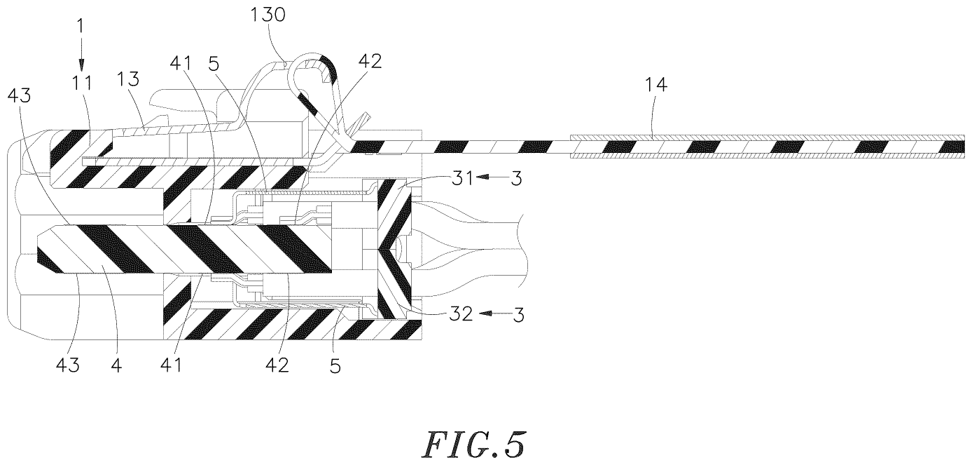

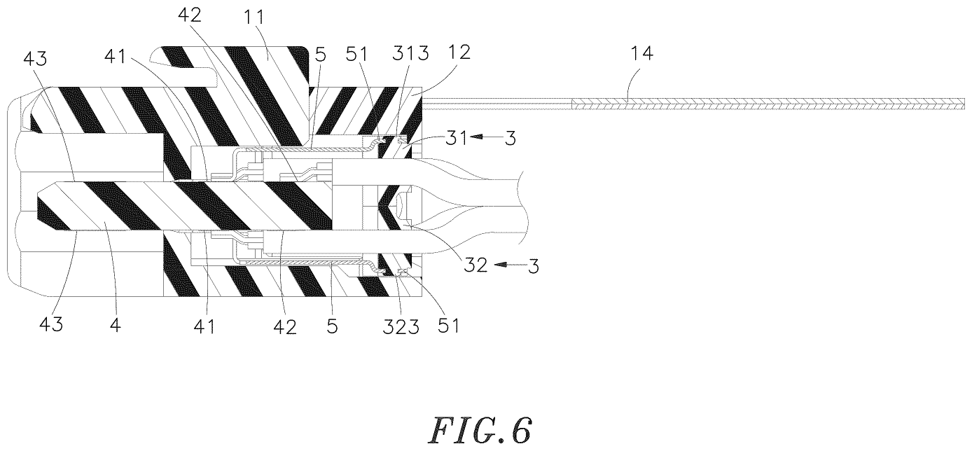

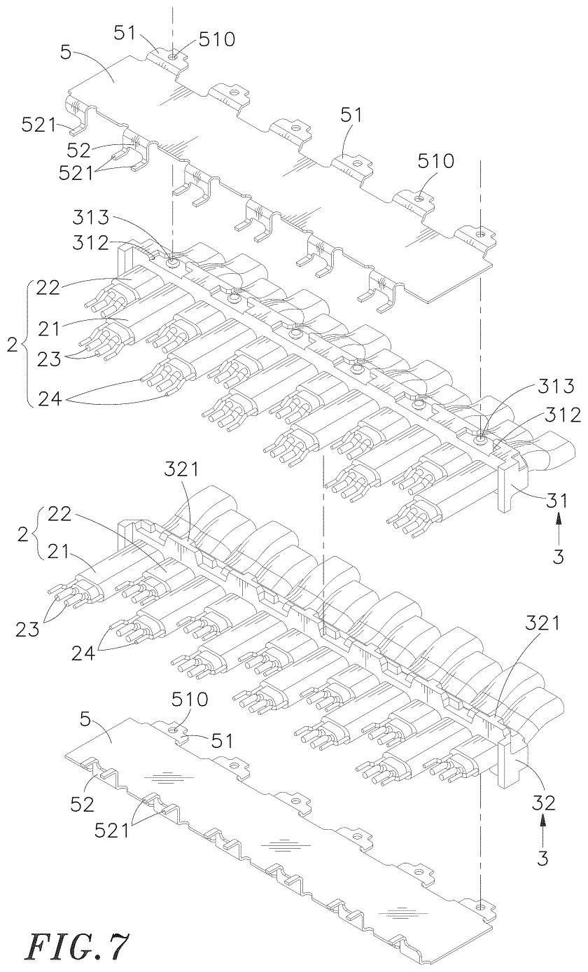

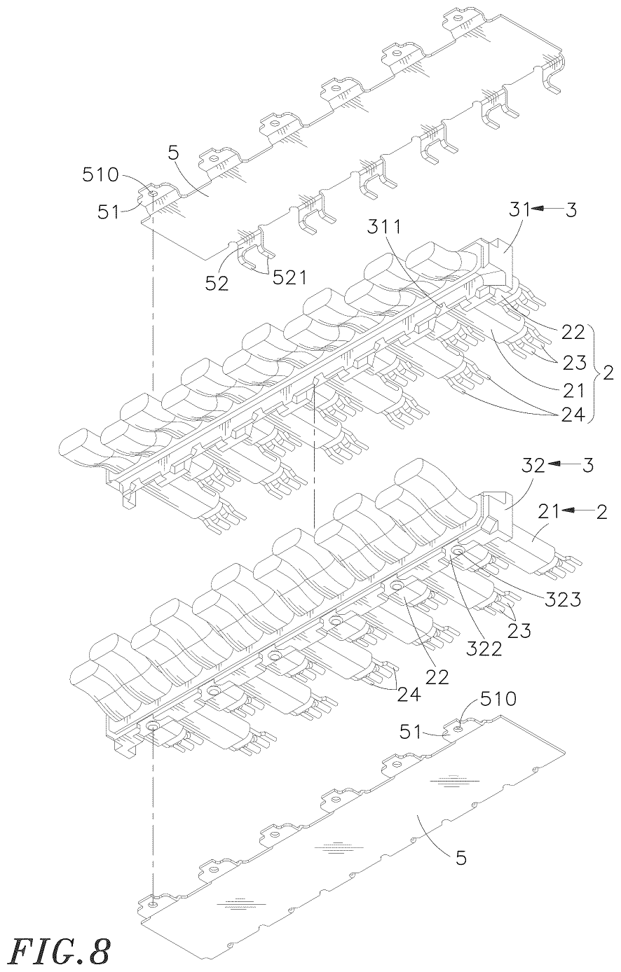

Please refer to FIGS. 1 to 8, which are respectively a three-dimensional external view of the electrical connector of the present invention, a three-dimensional external view of the electrical connector of the present invention from another viewing angle, a three-dimensional exploded view of the electrical connector of the present invention, a three-dimensional exploded view of the electrical connector of the present invention from another viewing angle, a side cross-sectional view of the electrical connector of the present invention, another side cross-sectional view of the electrical connector of the present invention, a more detailed three-dimensional exploded view of the internal components of the electrical connector of the present invention and a more detailed three-dimensional exploded view from another viewing angle of the internal components of the electrical connector of the present invention. As can be clearly seen from the figures, the electrical connector of the present invention mainly comprises an insulating housing 1, and a plurality of cables 2, a wire rack assembly 3 and a circuit board 4 arranged in the insulating housing 1. Its main components and features are described in detail as follows:

The plurality of cables 2 comprise a plurality of front-row cables 21 of longer length and a plurality of rear-row cables 22 of shorter length, and the front-row cables 21 and the rear-row cables 22 are arranged in a staggered manner.

The wire rack assembly 3 is formed outside the cables 2 and forms a predetermined spacing between the adjacent front-row cables 21 and the rear-row cables 22. The wire rack assembly 3 formed on the outside of the plurality of cables 2 can provide a fixed spacing between the front-row cables 21 and the rear-row cables 22 to reduce the coupling effect between adjacent cables 2 and improve the near-end crosstalk (NEXT) and far-end crosstalk (FEXT) problems of the cables 2.

The circuit board 4 comprises a plurality of front-row solder pads 41 located on at least one surface thereof for soldering the wire cores (including signal wire cores 23 and ground wire cores 24) of the front-row cables 21 on the front side of the wire rack assembly 3, a plurality of rear-row solder pads 42 for soldering the wire cores (including the signal wire cores 23 and the ground wire cores 24) of the rear-row cables 22, and a plurality of contacts 43 provided on the other side of the front-row solder pads 41 relative to the rear-row solder pads 42 to provide a mutual power connector (not shown) for corresponding coupling and electronic signal transmission. The front-row solder pads 41 and the rear-row solder pads 42 are arranged in a staggered manner. The front-row cables 21 and the rear-row cables 22 are arranged in a front-to-back staggered manner on the circuit board 4 to improve the far-end crosstalk problem when transmitting high-frequency signals.

The insulating housing 1 comprises an outer housing 11 and an inner housing 12 which are connected to each other. The outer housing 11 is used for fixing the circuit board 4, and the inner housing 12 for fixing the wire rack assembly 3 is fixed inside the outer housing 11 through buckles 121 of the inner housing 12 and fixing grooves 111 of the outer housing 11 and the insert molding method, and the space between the outer housing 11, the inner housing 12 and the plurality of cables 2 is filled with plastic material to control impedance variation and reduce insertion loss and return loss. The outer housing 11 of the insulating housing 1 is provided with a receiving groove 112 on the top side thereof and the receiving groove 112 accommodates a locking spring sheet 13 formed of a metal plate. The locking spring sheet 13 is provided with a strap hole 130 on the top side thereof and a pull strap 14 for unlocking is installed in the strap hole 130.

The wire rack assembly 3 mentioned above comprises an upper wire rack 31 and a lower wire rack 32 that can be connected to each other through latches 321 and latch slots 311, and the upper wire rack 31 and the lower wire rack 32 are both made of an integrally molded plastic material. A plurality of positioning grooves 312 are disposed on the opposite outer sides of the upper wire rack 31 and the lower wire rack 32, and a plurality of protruding buckles 313 are disposed on the positioning grooves 312 for positioning a plurality of buckle grooves 510 of a grounding plate 5. The protruding buckles 313 are deformed and expanded at the top by heating and pressing to fix the grounding plate 5. The grounding plate 5 is a flat plate structure, so that the upper wire rack 31 and the lower wire rack 32 are fixed with the grounding plate 5 on their opposite outer sides. The grounding plate 5 comprises a plurality of fixing portions 51 with the buckle grooves 510 on one side, and a plurality of welding portions 52 extending downwardly and bent on the other side, and each welding portion 52 has at least one grounding pin 521 welded to the front-row solder pads 41 of the circuit board 4 at the end thereof. The grounding plate 5 disposed on the opposite outer sides of the upper wire rack 31 and the lower wire rack 32 can absorb the electromagnetic waves generated when the cables 2 transmit high-frequency signals. The grounding pins 521 of the grounding plate 5 can guide the current converted from the electromagnetic waves to the front row solder pads 41 of the circuit board 4, and then guide it from the front-row solder pads 41 to the inner layer of the circuit board 4 or the grounding area of other components for elimination, thereby greatly reducing the electromagnetic interference (EMI) effect.

The front-row cables 21 and the rear-row cables 22 each comprise four wire cores, namely two signal wire cores 23 located in the center and two ground wire cores 24 located at two outer sides. The front-row solder pads 41 and the rear-row solder pads 42 of the circuit board 4 correspond to the wire cores of the front-row cables 21 and the wire cores of the rear-row cables 22 and are also four parallel solder pads. The width of the four front-row solder pads 41 in parallel at the two outer positions is greater than the width at the two central positions. The two ground wire cores 24 and the grounding pins 521 of the grounding plate 5 are coupled to two outer positions of the front-row solder pads 41 at the same time.

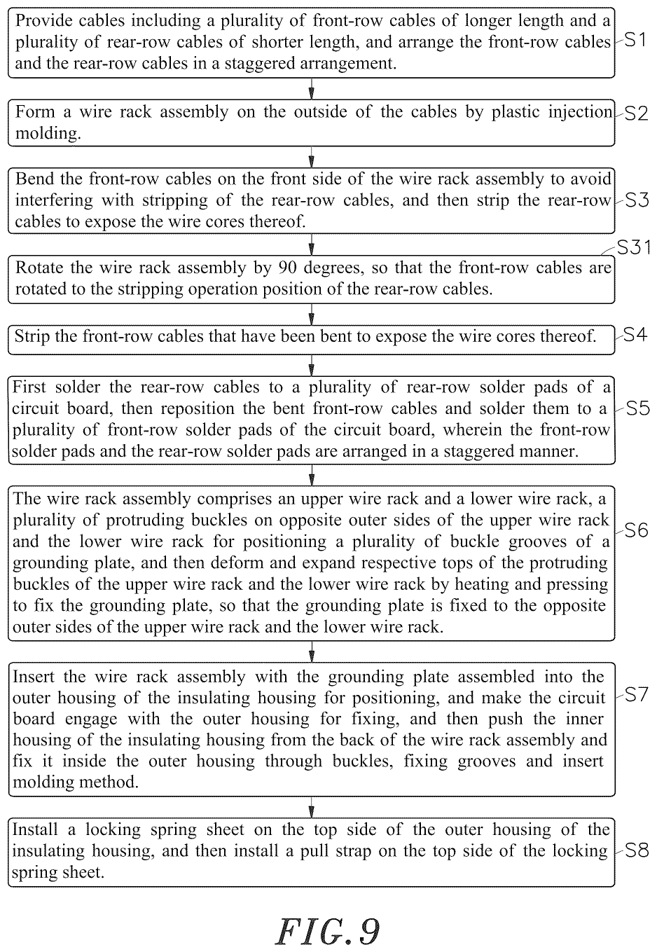

According to the electrical connector structure disclosed in FIGS. 1 to 8, please refer to FIG. 9, which is a flow chart of the electrical connector manufacturing method of the present invention, comprising the following steps:
Step S1: Provide a plurality of cables including a plurality of front-row cables of longer length and a plurality of rear-row cables of shorter length, and arrange the front-row cables and the rear-row cables in a staggered arrangement.
Step S2: Form a wire rack assembly on the outside of the cables by plastic injection molding.
Step S3: Bend the front-row cables on the front side of the wire rack assembly to avoid interfering with stripping of the rear-row cables, and then strip the rear-row cables to expose the wire cores thereof.
Step S31: Rotate the wire rack assembly by 90 degrees, so that the front-row cables are rotated to the stripping operation position of the rear-row cables.
Step S4: Strip the front-row cables that have been bent to expose the wire cores thereof.
Step S5: First solder the rear-row cables to a plurality of rear-row solder pads of a circuit board, then reposition the bent front-row cables and solder them to a plurality of front-row solder pads of the circuit board, wherein the front-row solder pads and the rear-row solder pads are arranged in a staggered manner.
Step S6: The wire rack assembly comprises an upper wire rack and a lower wire rack, a plurality of protruding buckles on opposite outer sides of the upper wire rack and the lower wire rack for positioning a plurality of buckle grooves of a grounding plate, and then deform and expand respective tops of the protruding buckles of the upper wire rack and the lower wire rack by heating and pressing to fix the grounding plate, so that the grounding plate is fixed to the opposite outer sides of the upper wire rack and the lower wire rack.
Step S7: Insert the wire rack assembly with the grounding plate assembled into the outer housing of the insulating housing for positioning, and make the circuit board engage with the outer housing for fixing, and then push the inner housing of the insulating housing from the back of the wire rack assembly and fix it inside the outer housing through buckles, fixing grooves and insert molding method.
Step S8: Install a locking spring sheet on the top side of the outer housing of the insulating housing, and then install a pull strap on the top side of the locking spring sheet.

The main feature of the present invention is that the plurality of front-row cables 21 and the plurality of rear-row cables 22 in the electrical connector are arranged in a front-to-back staggered manner on the circuit board 4 to improve the far-end crosstalk problem when transmitting high-frequency signals; furthermore, the wire rack assembly 3 formed outside the plurality of cables 2 can provide a fixed distance between the front-row cables 21 and the rear-row cables 22 to reduce the coupling effect between adjacent cables 2 and improve the near-end crosstalk and far-end crosstalk problems of the cables 2.

The above are merely a preferred embodiment of the present invention and is not intended to limit the patent scope of the present invention. Therefore, all simple modifications and equivalent structural changes made by using the contents of the description and drawings of the present invention should be included in the patent scope of the present invention and should be declared.

In summary, the electrical connector manufacturing method of the present invention can achieve its effect and purpose when used. Therefore, this invention is truly an invention with excellent practicality. In order to meet the application requirements for invention patents, an application has been filed in accordance with the law. I hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. An electrical connector manufacturing method, comprising steps of:
S1: providing a plurality of cables including a plurality of front-row cables of a longer length and a plurality of rear-row cables of a shorter length, and arranging said front-row cables and said rear-row cables in a staggered manner;
S2: forming a wire rack assembly on an outside of said cables by plastic injection molding;
S3: bending said front-row cables on a front side of said wire rack assembly to avoid interfering with stripping of said rear-row cables, and then stripping said rear-row cables to expose wire cores thereof;
S4: stripping said front-row cables that have been bent to expose the wire cores thereof; and
S5: first, soldering said rear-row cables to a plurality of rear-row solder pads of a circuit board, and then restoring the bent said front-row cables and soldering said front-row cables to a plurality of front-row solder pads of said circuit board to keep said front-row solder pads and said rear-row solder pads in a staggered manner.

2. The electrical connector manufacturing method as claimed in claim 1, further comprising step S31 between step S3 and step S4 to rotate said wire rack assembly 90 degrees so as to rotate said front-row cables to the stripping position of said rear-row cables, and then perform step S4.

3. The electrical connector manufacturing method as claimed in claim 1, further comprising step S6, wherein said wire rack assembly comprises an upper wire rack and a lower wire rack, a plurality of protruding buckles on opposite outer sides of said upper wire rack and said lower wire rack for positioning a plurality of buckle grooves of a grounding plate and then deform and expand respective tops of said protruding buckles of said upper wire rack and said lower wire rack by heating and pressing to fix said grounding plate, so that said grounding plate is fixed to opposite outer sides of said upper wire rack and said lower wire rack.

4. The electrical connector manufacturing method as claimed in claim 1, further comprising step S7 to insert said wire rack assembly with said grounding plate assembled into an outer housing of an insulating housing for positioning, and make said circuit board engage with said outer housing for fixing, and then push said inner housing of said insulating housing from a back of said wire rack assembly and fix said inner housing inside said outer housing through buckles, fixing grooves and insert molding method.

5. The electrical connector manufacturing method as claimed in claim 1, further comprising step S8 to install a locking spring sheet on a top side of an outer housing of an insulating housing, and then install a pull strap on a top side of said locking spring sheet.
